(19) United States
(12) Patent Application Publication
(10) Pub. No.: US 2002/0181054 A1
(43) Pub. Date: Dec. 5, 2002

(54) Expansion apparatus with optical attenuation filter for adjusting gain of optical signal

(76) Inventor: Koichi Kaji, Hidaka-shi (JP)

Correspondence Address: Pillsbury Winthrop LLP, 725 South Figueroa Street, Suite 2800, Los Angeles, CA, 90017-5406, US

(21) Appl. No.: 10/157,256

(22) Filed: May 29, 2002

(30) Foreign Application Priority Data
May 30, 2001 (JP) 2001-162714

(51) Int. Cl. H04B 10/00

(52) U.S. Cl. 359/154; 359/163

(57) ABSTRACT

An expansion apparatus for an electronic apparatus includes an apparatus main body, a second optical communication device, and a gain adjustment mechanism. The second optical communication device includes a light-emitting section which transmits an optical signal to a first optical communication device incorporated in the electronic apparatus, and a light-receiving section which receives an optical signal from the first optical communication device. The gain adjustment mechanism is interposed between the first and second optical communication devices when the electronic apparatus is placed in a predetermined positional relationship to the apparatus main body, thereby adjusting the gain of an optical signal exchanged between the first and second optical communication devices.

### CROSS-REFERENCE TO RELATED APPLICATIONS

This application is based upon and claims the benefit of priority from prior Japanese Patent Application No. 2001-162714, filed May 30, 2001.

### BACKGROUND OF THE INVENTION

1. Field of the Invention

The present invention relates to an expansion apparatus for transmitting and receiving data to and from an electronic apparatus via an optical communication function using infrared light, and an electronic apparatus system using the expansion apparatus.

2. Description of the Related Art

For portable computers, it is important to enhance the portability in order to increase their value as a commodity. To this end, portable computers are designed thin and compact. This characteristic, however, makes it difficult to secure a sufficient space for, for example, connectors for connection to a peripheral device such as an external keyboard, memory device, etc. Therefore, in conventional portable computers, their functions are expanded using an expansion apparatus, such as a docking station or a port replicator.

As one of these, an expansion apparatus that transmits and receives data to and from a portable computer via its optical communication function using infrared light is known. This expansion apparatus is provided with a mount section for temporary mounting of a portable computer, and an optical communication device installed in the mount section. The optical communication device includes a light-emitting diode for transmitting an optical signal to a communication port incorporated in a portable computer, and a photodiode for receiving an optical signal transmitted from the communication port. The light-emitting diode and photodiode face the communication port of the portable computer mounted on the mount section to enable optical communication to take place.

The communication port and optical communication device are covered with respective optical filters for selectively passing an optical signal therethrough. When the portable computer is mounted on the mount section, these filters are located close to each other. This positional relationship prevents an optical communication path, formed between the communication port and optical communication device, from being exposed to unwanted external light, such as sunlight.

In conventional expansion apparatuses, the intensity of an optical signal is set on the assumption that the optical communication device executes optical communication with a portable computer mounted on the mount section. Accordingly, if optical communication is executed with the portable computer and expansion apparatus kept at a distance, the degree of attenuation of an optical signal that enters the photodiode is increased. As a result, a transmission error may easily occur, or the data transmission efficiency may be reduced, which thereby increases the time required for data transmission.

On the other hand, where the intensity of an optical signal is set on the assumption that the optical communication device is used at a distance from the portable computer, if the optical communication device is located close to the portable computer, the dynamic range of an optical signal that enters the photodiode becomes too high. As a result, the photodiode may malfunction, thereby causing a transmission error.

Thus, the gain of the optical communication path and hence the optical communication performance significantly differs between the case where the portable computer is located close to the expansion apparatus, and the case where they are located at a distance.

### BRIEF SUMMARY OF THE INVENTION

It is an object of the invention to provide an expansion apparatus capable of suppressing variations in optical communications performance, thereby realizing reliable optical communication.

It is another object of the invention to provide an electronic apparatus system capable of reliable optical communication between an electronic apparatus and an expansion apparatus.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of an electronic apparatus system according to a first embodiment of the invention, illustrating a positional relationship between a communication port of a portable computer and that of an expansion apparatus;

FIG. 2 is a sectional view of the electronic apparatus system of the first embodiment, illustrating a state in which the communication port of the portable computer and that of the expansion apparatus are located at a distance;

FIG. 3 is a sectional view of the electronic apparatus system of the first embodiment, illustrating a state in which the communication port of the portable computer and that of the expansion apparatus are located close to each other;

FIG. 4 is a schematic front view illustrating a state in which an optical attenuation filter is slid to a second position in a second embodiment;

FIG. 5 is a schematic front view illustrating a state in which the optical attenuation filter is slid to a first position in the second embodiment;

FIG. 6 is a schematic plan view illustrating a positional relationship between first and second pinions, a second link lever and an operation lever in the second embodiment;

FIG. 7 is a schematic front view illustrating a state in which an optical attenuation filter is slid to a second position in a third embodiment;

FIG. 8 is a circuit diagram illustrating a state in which a movable contact of a detection switch is slid to a second switchover position in a third embodiment; and

FIG. 9 is a circuit diagram illustrating a state in which the movable contact of the detection switch is slid to a first switchover position in the third embodiment.

### DETAILED DESCRIPTION OF THE INVENTION

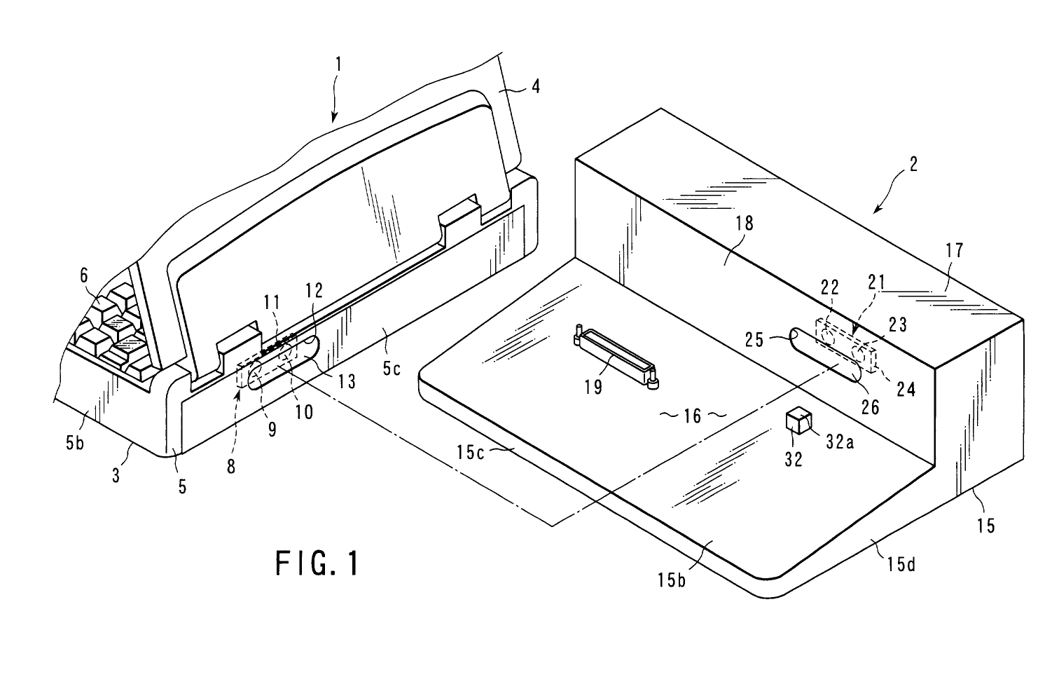

Referring to FIGS. 1-3, a first embodiment of the invention will be described.

FIG. 1 shows a portable computer 1 as an electronic apparatus, and an expansion apparatus 2 used to expand the functions of the portable computer 1. The portable computer 1 comprises a computer main body 3 and a display unit 4.

The computer main body 3 includes a flat box-shaped housing 5. The housing 5 has a bottom wall 5a, left and right side walls 5b and rear wall 5c. A keyboard 6 is mounted on the upper surface of the housing 5. The display unit 4 is pivotably attached to the rear end of the housing 5 by hinge members (not shown).

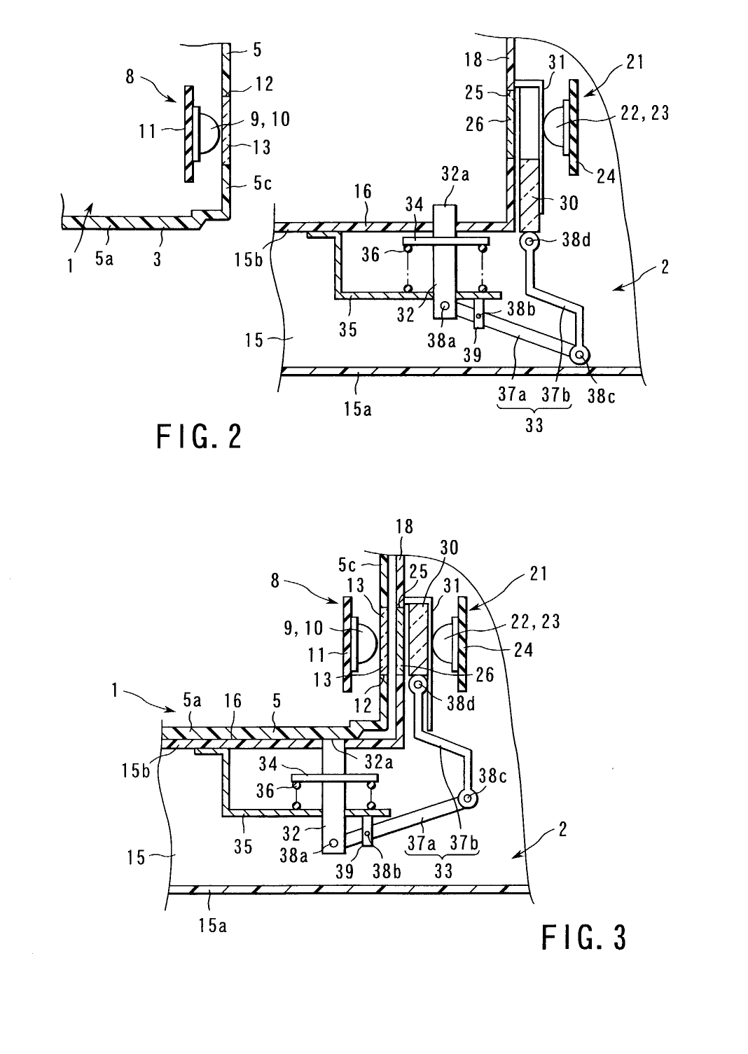

As shown in FIGS. 1 and 2, the housing 5 houses a first optical communication device 8. The first optical communication device 8 is used to transmit and receive data to and from the expansion apparatus 2, using infrared optical signals. The first optical communication device 8 comprises a light-emitting diode 9 for transmitting an optical signal, a photodiode 10 for receiving an optical signal, and a printed circuit board 11 that supports the diodes 9 and 10. The diodes 9 and 10 are arranged in line along the rear wall 5c of the housing 5.

The rear wall 5c of the housing 5 has a communication port 12 opposed to the diodes 9 and 10. The communication port 12 is covered with a first optical filter 13. The properties of the first optical filter 13 enable infrared light to be selectively passed through it. The first optical filter 13 forms part of the rear wall 5c of the housing 5.

As shown in FIG. 1, the expansion apparatus 2 has a main body 15. The apparatus main body 15 is flat box-shaped and includes a bottom wall 15a, upper wall 15b, front wall 15c and left and right side walls 15d. The apparatus main body 15 is designed to be placed on, for example, the top of a desk.

The upper wall 15b of the apparatus main body 15 serves as a flat mount section 16. The rear portion of the housing 5 of the portable computer 1 is dismountably mounted on the mount section 16. The apparatus main body 15 has a hollow projecting portion 17 on the rear side. The projecting portion 17 extends lengthwise, and has a vertical wall 18. The vertical wall 18 upwardly projects from the rear end of the mount section 16. When the portable computer 1 is mounted on the mount section 16, the vertical wall 18 faces the rear wall 5c of the housing 5.

The apparatus main body 15 contains an expansion device (not shown) such as an optical disk drive. Further, a plurality of interface connectors (not shown) for connection to a peripheral device such as a mouse or an external memory device, or to a communication cable are provided on the rear surface of the projecting portion 17 of the apparatus main body 15. The expansion device and interface connectors are used to expand the functions of the portable computer 1.

As shown in FIG. 1, an expansion connector 19 is provided on the mount section 16 of the apparatus main body 15. The expansion connector 19 is used as an auxiliary when optical communication using infrared light is not executed between the expansion apparatus 2 and portable computer 1, or when data is exchanged between the expansion apparatus 2 and a peripheral unit that does not execute optical communication. The expansion connector 19 is electrically connected to the expansion device or interface connectors.

The projecting portion 17 of the apparatus main body 15 contains a second optical communication device 21. The second optical communication device 21 is used to exchange data with the first optical communication device 8 of the portable computer 1. The second optical communication device 21 includes a light-emitting diode 22 for transmitting an optical signal, a photodiode 23 for receiving an optical signal, and a printed circuit board 24 that supports the diodes 22 and 23.

The light-emitting diode 22 and photodiode 23 are arranged in line along the vertical wall 18 of the apparatus main body 15. The distance between the diodes 22 and 23 is equal to that between the diodes 9 and 10 of the first optical communication device 8. Accordingly, when the housing 5 of the portable computer 1 is placed on the mount section 16, the light-emitting diode 22 faces the photodiode 10, and the photodiode 23 faces the light-emitting diode 9.

The vertical wall 18 of the apparatus main body 15 has a communication port 25 opposed to the diodes 22 and 23. The communication port 25 is covered with a second optical filter 26. The properties of the second optical filter 26 allow infrared light to be selectively passed therethrough, and this filter forms part of the vertical wall 18. Further, the communication port 25 faces the communication port 12 of the portable computer 1 when the computer is placed on the mount section 16.

Accordingly, the first optical filter 13 of the computer 1 is opposed to the second optical filter 26 of the expansion apparatus 2 with a slight gap therebetween, when the housing 5 of the computer 1 is mounted on the mount section 16 of the expansion apparatus 2. The first and second optical filters 13 and 26 may abut against each other.

When the computer 1 is used and connected to the expansion apparatus 2, an optical signal transmitted from the light-emitting diode 9 of the first optical communication device 8 enters the photodiode 23 of the second optical communication device 21 through the first and second optical filters 13 and 26. Similarly, an optical signal transmitted from the light-emitting diode 22 of the second optical communication device 21 enters the photodiode 10 of the first optical communication device 8 through the first and second optical filters 13 and 26. Thus, optical communication using infrared light is executed between the computer 1 and expansion apparatus 2, thereby exchanging data therebetween.

As shown in FIGS. 2 and 3, the apparatus main body 15 contains an optical attenuation filter 30 serving as a gain adjustment mechanism. The optical attenuation filter 30 attenuates an optical signal transmitted between the computer 1 and expansion apparatus 2. The filter 30 is a plate-like member of a size corresponding to the communication port 25. The filter 30 is slidably engaged with a guide rail 31 provided on the inner surface of the vertical wall 18. The guide rail 31 vertically extends along the vertical wall 18.

Accordingly, the optical attenuation filter 30 is vertically slidable between a first position (shown in FIG. 3) in which it is advanced in front of the light-emitting diode 22 and photodiode 23, and a second position (shown in FIG. 2) in which it is retracted below the diodes 22 and 23.

The apparatus main body 15 contains a detection bar 32 and operation link mechanism 33. The detection bar 32 is used to mechanically detect whether or not the housing 5 of the portable computer 1 is mounted on the mount section 16. The detection bar 32 is located at a rear end portion of the mount section 16. The detection bar 32 is supported by the apparatus main body 15 such that it vertically extends. The detection bar 32 extends through the mount section 16, and has a flange-shaped spring seat 34 at its axially middle portion. A helical compression spring 36 is interposed between the spring seat 34 and a bracket 35 fixed to the lower surface of the mount section 16.

In this structure, the detection bar 32 is vertically movable between a “standby” position (shown in FIG. 2) in which its upper end 32a projects from the mount section 16, and a detection position (shown in FIG. 3) in which the upper end 32a is pushed below the mount section 16. The helical compression spring 36 continuously presses the detection bar 32 toward the standby position.

As shown in FIG. 3, when the housing 5 of the portable computer 1 is mounted on the mount section 16, the bottom wall 5a of the housing 5 abuts against the upper end 32a of the detection bar 32. As a result, the detection bar 32 is pushed downwards by the weight of the computer 1 from the standby position to the detection position.

The operation mechanism 33 is used to shift the optical attenuation filter 30 to the first or second position. The operation mechanism 33 includes first and second link levers 37a and 37b. The first link lever 37a extends in the depth direction of the apparatus main body 15. The first link lever 37a has a front end rotatably coupled by a pin 38a to the lower end of the detection bar 32, and an intermediate portion rotatably coupled by a pin 38b to a stay 39 that downwardly extends from the bracket 35. Accordingly, the first link lever 37a can swing about the pin 38b in synchrony with the vertical movement of the detection bar 32.

The second link lever 37b extends in the height direction of the apparatus main body 15. The second link lever 37b has a lower end rotatably coupled by a pin 38c to the rear end of the first link lever 37a, and an upper end rotatably coupled by a pin 38d to the lower end of the optical attenuation filter 30.

FIG. 2 shows a state in which the detection bar 32 is in to the standby position. As long as the detection bar 32 is in the standby position, the rear end of the first link lever 37a is kept lower than the front end, thereby downwardly pulling the second link lever 37b. Accordingly, the optical attenuation filter 30 is maintained in the second position, retracted from the light-emitting diode 22 and photodiode 23.

FIG. 3 shows a state in which the detection bar 32 is pushed down from the standby position to the detection position. When the detection bar 32 is in the detection position, the first link lever 37a counterclockwise rotates about the pin 38b. In accordance with this rotation, the second link lever 37b raises the optical attenuation filter 30 from the second position to the first position. Thus, when the detection bar 32 is in the detection position, the optical attenuation filter 30 is advanced in front of the diodes 22 and 23 and aligned with the second optical filter 26.

In the above-described structure, it is not necessary to connect the expansion apparatus 2 to the portable computer 1 for a long time, in order to upload data, stored in the portable computer 1, to a host computer (not shown) via the expansion apparatus 2, or to download data from the host computer to the portable computer 1 via the expansion apparatus 2. In light of this, when uploading or downloading data, the portable computer 1 may be positioned in front of the expansion apparatus 2, i.e. not connecting it, with the communication ports 12 and 25 opposing each other.

In this state, the communication ports 12 and 25 of the computer 1 and expansion apparatus 2 are at a distance from each other, which means that the optical communication path therebetween is long. Furthermore, since the portable computer 1 is not mounted on the mount section 16 of the expansion apparatus 2, the detection bar 32 of the apparatus 2 is kept in the standby position, in which its upper end 32a projects from the mount section 16. As a result, the optical attenuation filter 30 is lowered to the second position by the operation mechanism 33, and is kept away from the communication ports 12 and 25 of the computer 1 and expansion apparatus 2, as is shown in FIG. 2.

Therefore, in this state, if optical communication is executed between the portable computer 1 and expansion apparatus 2, the optical signal from the light-emitting diode 9 of the computer 1 only passes through first and second optical filters 13 and 26, not through the optical attenuation filter 30, before reaching photodiode 23 of the expansion apparatus 2. Similarly, the optical signal from the light-emitting diode 22 of the expansion apparatus 2 only passes through the first and second optical filters 13 and 26, not through the optical attenuation filter 30, before reaching the photodiode 10 of the portable computer 1.

On the other hand, when the portable computer 1 is used with its functions expanded, it is necessary to connect the computer 1 to the expansion apparatus 2 for a long time. Therefore, the housing 5 of the computer 1 is mounted on the mount section 16 of the expansion apparatus 2.

In this state, the communication ports 12 and 25 of the portable computer 1 and expansion apparatus 2 are opposed to each other, and hence the first and second optical filters 13 and 26 are close to each other, as is shown in FIG. 3. Thus, the optical communication path between the first and second optical filters 13 and 26 is extremely short, as compared to the case of exchanging data with the portable computer 1 positioned away from of the expansion apparatus 2.

Furthermore, since the portable computer 1 is placed on the mount section 16, the detection bar 32 is pushed from the standby position to the detection position by the housing 5 of the computer 1. As a result, the computer 1 is detected, and the movement of the detection bar 32 is transmitted to the optical attenuation filter 30 via the first and second link levers 37a and 37b, thereby raising the filter 30 from the second position to the first position. Thus, the optical attenuation filter 30 is advanced between the diodes 22, 23 and optical filter 26 of the expansion apparatus 2.

In this state, if optical communication is executed between the portable computer 1 and expansion apparatus 2, an optical signal from the light-emitting diode 9 of the computer 1 enters the photodiode 23 of the expansion apparatus 2 through the optical attenuation filter 30 and first and second optical filters 13 and 26. The optical signal is thus attenuated when it passes through the attenuation filter 30.

Similarly, an optical signal from the light-emitting diode 22 of the expansion apparatus 2 enters the photodiode 10 of the portable computer 1 through the optical attenuation filter 30 and first and second optical filters 13 and 26. The optical signal is thus attenuated when it passes through the attenuation filter 30.

In the above-described first embodiment, if the intensity of the optical signal is set on the assumption that optical communication is executed with the portable computer 1 kept away from the expansion apparatus 2, the optical signal is prevented from being significantly attenuated between the computer 1 and expansion apparatus 2, even if the computer and expansion apparatus are positioned such that the optical communication path therebetween is long.

In addition, if the optical communication path is extremely short, as in the case where the portable computer 1 is mounted on the mount section 16 of the expansion apparatus 2, the optical attenuation filter 30 is automatically interposed between the second optical filter 26 and second optical communication device 21 for adjusting the gain of the optical communication path. As a result, the dynamic range of the optical signal that enters the photodiode 10 or 23 is prevented from becoming excessive.

Therefore, transmission errors do not easily occur during optical communication between the portable computer 1 and the expansion apparatus 2 in both the arrangement where the portable computer 1 is positioned remote from the expansion apparatus 2 and the computer 1 is mounted on the mount section 16 of the expansion apparatus 2. This means that the optical communication performance is enhanced and hence optical communication can be executed reliably.

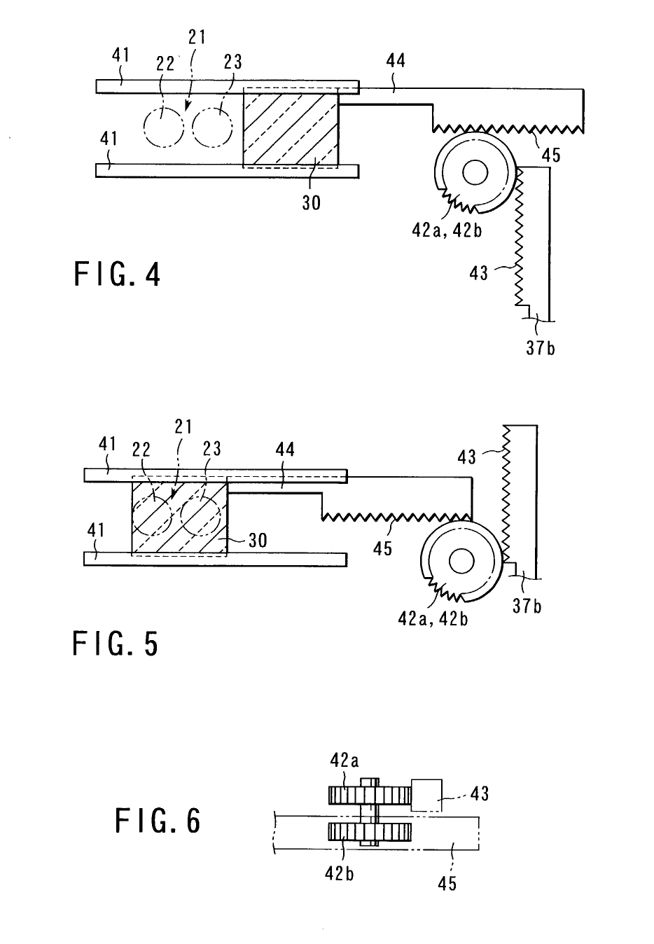

The present invention is not limited to the above-described first embodiment. Referring now to FIGS. 4 to 6, a second embodiment will be described.

The second embodiment differs from the first embodiment in that in the former, the optical attenuation filter 30 is horizontally slidable along the length of the expansion apparatus 2. The other basic structures of the second embodiment are similar to those of the first embodiment. Therefore, in the second embodiment, the elements similar to those of the first embodiment are denoted by corresponding reference numerals, and no detailed description is given thereof.

As shown in FIG. 4, the optical attenuation filter 30 is slidably engaged with a pair of guide rails 41 provided on the inner surface of the vertical wall 18. The guide rails 41 extend parallel to each other along the length of the apparatus main body 15.

Accordingly, the optical attenuation filter 30 is horizontally slidable between a first position (shown in FIG. 5) in which it is advanced in front of the light-emitting diode 22 and photodiode 23, and a second position (shown in FIG. 4) in which it is laterally retracted from the diodes 22 and 23.

First and second pinions 42a and 42b are provided beside the optical attenuation filter 30. As seen from FIG. 6, the first and second pinions 42a and 42b are linked coaxially, thus rotate in the same direction.

The second link lever 37b, which moves in accordance with the vertical movement of the detection bar 32, has an upper end portion with a rack 43. The rack 43 is engaged with the first pinion 42a. The optical attenuation filter 30 has an operation lever 44. The lever 44 horizontally extends to the second pinion 42b and has a free end with a rack 45. The rack 45 is engaged with the second pinion 42b.

The first and second pinions 42a and 42b rotate in the same direction in synchrony with the vertical movement of the second link lever 37b. The rotation of the first and second pinions 42a and 42b is converted into a linear movement and transmitted to the operation lever 44. The optical attenuation filter 30 is slid to the first or second position according to the direction of rotation of the pinions 42a and 42b.

Thus, in the second embodiment, the first and second pinions 42a and 42b and racks 43 and 45 provide an operation mechanism for moving the optical attenuation filter 30.

In the second embodiment constructed as above, when radio communication is executed with the portable computer 1 positioned at a distance from the expansion apparatus 2, the computer 1 is not mounted on the mount section 16 of the apparatus 2. Accordingly, the detection bar 32 is in the standby position. In this state, the second link lever 37b is pulled down, and the first and second pinions 42a and 42b are clockwise rotated by the second link lever 37b. The rotation of the second pinion 42b is converted into a linear movement by the rack 45 and transmitted to the operation lever 44, with the result that the optical attenuation filter 30 is slid to the second position. Thus, as long as the detection bar 32 is in the standby position, the optical attenuation filter 30 is kept in the second position, in which the filter 30 is retracted from the optical communication path between the communication ports 25 and 12 of the expansion apparatus 2 and portable computer 1.

When, on the other hand, the portable computer 1 is mounted on the mount section 16 of the expansion apparatus 2, the housing 5 of the computer 1 pushes down the detection bar 32, thereby counterclockwise rotating the first and second pinions 42a and 42b. The rotation of the second pinion 42b is converted into a linear movement by the rack 45 and transmitted to the operation lever 44, with the result that the optical attenuation filter 30 is slid to the first position. As a result, the optical attenuation filter 30 is advanced in front of the light-emitting diode 22 and photodiode 23. In this state, the filter 30 is interposed between the communication ports 25 and 12 of the expansion apparatus 2 and portable computer 1.

Accordingly, also in the second embodiment, the optical attenuation filter 30 can be advanced to and retracted from the optical communication path depending upon the positional relationship between the portable computer 1 and expansion apparatus 2. Therefore, the gain of the optical communication path can be adjusted.

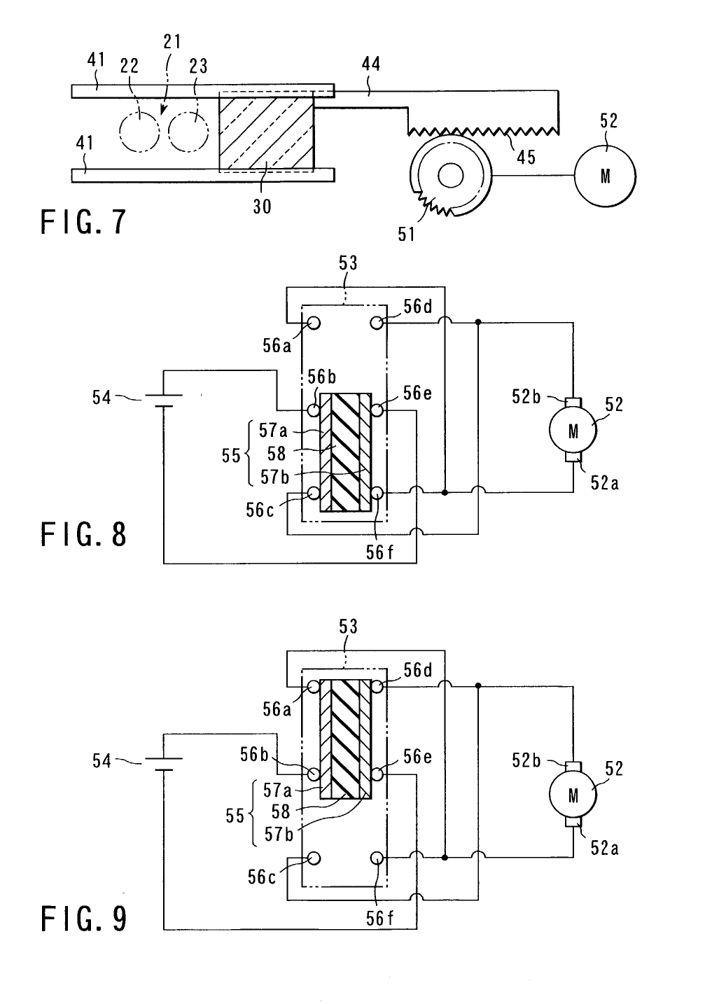

Referring to FIGS. 7-9, a third embodiment of the invention will be described.

The third embodiment differs from the second embodiment in that, in the former, whether or not the portable computer 1 is mounted on the mount section 16 is electrically detected, and a motor 52 is used to slide the optical attenuation filter 30.

As shown in FIG. 7, the rack 45 of the operation lever 44 is engaged with a single pinion 51, and this pinion is connected to the motor 52, for rotation in clockwise or counterclockwise directions. The motor 52 is connected to a power supply 54 via the detection switch 53 shown in FIG. 8. The detection switch 53 electrically detects whether or not the portable computer 1 is mounted on the mount section 16. The switch 53 includes a movable contact 55 and first to sixth stationary contacts 56a-56f.

The movable contact 55 has a pair of conductive plates 57a and 57b, and an insulator 58 interposed therebetween. The movable contact 55 is arranged to slide in accordance with, for example, the vertical movement of the detection bar 32.

The movable contact 55 is interposed between the first to third stationary contacts 56a-56c and the fourth to sixth stationary contacts 56d-56f. The first to third stationary contacts 56a, 56b and 56c correspond to the conductive plate 57a, and are arranged linearly at regular intervals in the sliding direction of the movable contact 55. The fourth to sixth stationary contacts 56d, 56e and 56f correspond to the other conductive plate 57b, and are arranged linearly at regular intervals in the sliding direction of the movable contact 55.

The second and fifth stationary contacts 56b and 56e are electrically connected to the positive and negative terminals of the power supply 54, respectively. The first and sixth stationary contacts 56a and 56f are electrically connected to one 52a of the terminals of the motor 52. Further, the third and fourth stationary contacts 56c and 56d are electrically connected to the other terminal 52b of the motor 52.

When the detection bar 32 is in the standby position, the movable contact 55 of the detection switch 53 is in the first switchover position shown in FIG. 9. In the first switchover position, the conductive plate 57a of the movable contact 55 electrically connects the first and second stationary contacts 56a and 56b, while the other conductive plate 57b electrically connects the fourth and fifth stationary contacts 56d and 56e.

Accordingly, the positive terminal of the power supply 54 is electrically connected to the terminal 52a of the motor 52 via the conductive plate 57a of the movable contact 55, and the first and second stationary contacts 56a and 56b. Further, the negative terminal of the power supply 54 is electrically connected to the other terminal 52b of the motor 52 via the other conductive plate 57b of the movable contact 55, and the fourth and fifth stationary contacts 56d and 56e.

In this connection arrangement, the pinion 51 is clockwise (in FIG. 7) rotated by the motor 52, thereby sliding the optical attenuation filter 30 to the second position. Thus, as long as the detection bar 32 is in the standby position, the optical attenuation filter 30 is kept in the second position and retracted from the light-emitting diode 22 and photodiode 23.

When the portable computer 1 is mounted on the mount section 16, the detection bar 32 is pushed down from the standby position to the detection position. As a result, the movable contact 55 of the detection switch 53 is slid by the detection bar 32 to the second switchover position shown in FIG. 8. In the second switchover position, the conductive plate 57a of the movable contact 55 electrically connects the second and third stationary contacts 56b and 56c, while the other conductive plate 57b electrically connects the fifth and sixth stationary contacts 56e and 56f.

Accordingly, the positive terminal of the power supply 54 is electrically connected to the other terminal 52b of the motor 52 via the conductive plate 57a of the movable contact 55, and the second and third stationary contacts 56b and 56c. Similarly, the negative terminal of the power supply 54 is electrically connected to the terminal 52a of the motor 52 via the other conductive plate 57b of the movable contact 55, and the fifth and sixth stationary contacts 56e and 56f.

In this connection, the motor 52 is electrically connected to the negative terminal of the power supply 54, not to the positive terminal, and the motor 52 reversely rotates. Therefore, the pinion 51 is counterclockwise (in FIG. 7) rotated by the motor 52, thereby sliding the optical attenuation filter 30 from the second position to the first position. Accordingly, the optical attenuation filter 30 advances in front of the light-emitting diode 22 and photodiode 23.

In the above-described third embodiment, whether or not the portable computer 1 is mounted on the mount section 16 of the expansion apparatus 2 is electrically detected, and the direction of rotation of the motor 52 is controlled on the basis of the detection result.

As a result, the optical attenuation filter 30 can be advanced to and retracted from the optical communication path, which means that the gain of the optical communication path can be adjusted as in the first or second embodiment.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An expansion apparatus for an electronic apparatus which includes a first optical communication device for transmitting and receiving an optical signal, the expansion apparatus comprising:
an apparatus main body;
a second optical communication device provided in the apparatus main body, the second optical communication device having a light-emitting section which transmits an optical signal to the first optical communication device, and a light-receiving section which receives an optical signal from the first optical communication device; and
a gain adjustment mechanism provided in the apparatus main body, the gain adjustment mechanism being interposed between the first optical communication device and the second optical communication device when the electronic apparatus is placed in a predetermined positional relationship to the apparatus main body, thereby adjusting a gain of an optical signal exchanged between the first optical communication device and the second optical communication device.

2. The expansion apparatus according to claim 1, wherein the first optical communication device and the second optical communication device include respective optical filters which selectively transmit therethrough the optical signal exchanged between the first optical communication device and the second optical communication device.

3. The expansion apparatus according to claim 1, wherein the gain adjustment mechanism is movable between a first position in which the gain adjustment mechanism is interposed between the first optical communication device and the second optical communication device, and a second position in which the gain adjustment mechanism is retracted from interposing between the first optical communication device and the second optical communication device, the gain adjustment mechanism being shifted to the first position when it has been determined that the electronic apparatus is situated close to the apparatus main body.

4. The expansion apparatus according to claim 3, wherein the apparatus main body includes a mount section which dismountably mounts thereon the electronic apparatus, a detection section which detects whether or not the electronic apparatus is mounted on the mount section, and an operation mechanism which moves the gain adjustment mechanism to one of the first position and the second position based on a detection result of the detection section.

5. The expansion apparatus according to claim 4, wherein the predetermined positional relationship is assumed when the electronic apparatus is mounted on the mount section.

6. An expansion apparatus for an electronic apparatus which includes a first optical communication device for transmitting and receiving an optical signal, the expansion apparatus comprising:
an apparatus main body;
a second optical communication device provided in the apparatus main body, the second optical communication device having a light-emitting section which transmits an optical signal to the first optical communication device, and a light-receiving section which receives an optical signal from the first optical communication device, the second optical communication device being close to the first optical communication device when the electronic apparatus is situated close to the apparatus main body; and
a gain adjustment mechanism provided in the apparatus main body, the gain adjustment mechanism being movable between a first position in which the gain adjustment mechanism is interposed between the first optical communication device and the second optical communication device, and a second position in which the gain adjustment mechanism is retracted from interposing between the first optical communication device and the second optical communication device, the gain adjustment mechanism being moved to the first position when the electronic apparatus is situated close to the apparatus main body, thereby adjusting a gain of an optical signal exchanged between the first optical communication device and the second optical communication device.

7. The expansion apparatus according to claim 6, wherein the apparatus main body includes a mount section which dismountably mounts thereon the electronic apparatus, a detection section which detects whether or not the electronic apparatus is mounted on the mount section, and an operation mechanism which moves the gain adjustment mechanism to one of the first position and the second position based on a detection result of the detection section.

8. The expansion apparatus according to claim 7, wherein the first optical communication device and the second optical communication device are close to each other when the electronic apparatus is mounted on the mount section.

9. An expansion apparatus for an electronic apparatus which includes a communication port for transmitting and receiving an optical signal, the expansion apparatus comprising:
an apparatus main body which mounts thereon the electronic apparatus;
an optical communication device provided in the apparatus main body, the optical communication device having a light-emitting section which transmits an optical signal to the communication port, and a light-receiving section which receives an optical signal from the communication port, the optical communication device being close to the communication port when the electronic apparatus is mounted on the apparatus main body;
an optical attenuation filter provided in the apparatus main body, the optical attenuation filter being movable between a first position in which the optical attenuation filter is interposed between the optical communication device and the communication port, and a second position in which the optical attenuation filter is retracted from interposing between the optical communication device and the communication port, the optical attenuation filter attenuating an optical signal exchanged between the optical communication device and the communication port, when the optical attenuation filter has been moved to the first position; and
an operation mechanism provided in the apparatus main body, the operation mechanism moving the optical attenuation filter to the first position when the electronic apparatus is mounted on the apparatus main body, and to the second position when the electronic apparatus is dismounted from the apparatus main body.

10. The expansion apparatus according to claim 9, further including a detection section which detects whether or not the electronic apparatus is mounted on the apparatus main body, and wherein the operation mechanism moves the optical attenuation filter to one of the first position and the second position based on a detection result of the detection section.

11. An electronic apparatus system, comprising:
an electronic apparatus including a first optical communication device which transmits and receives an optical signal; and
an expansion apparatus which expands a function of the electronic apparatus, the expansion apparatus including
a second optical communication device having a light-emitting section which transmits an optical signal to the first optical communication device, and a light-receiving section which receives an optical signal from the first optical communication device, and
a gain adjustment mechanism interposed between the first optical communication device and the second optical communication device when the electronic apparatus is placed in a predetermined positional relationship to the expansion apparatus, thereby adjusting a gain of an optical signal exchanged between the first optical communication device and the second optical communication device.

12. The electronic apparatus system according to claim 11, wherein the gain adjustment mechanism is movable between a first position in which the gain adjustment mechanism is interposed between the first optical communication device and the second optical communication device, and a second position in which the gain adjustment mechanism is retracted from interposing between the first optical communication device and the second optical communication device, the gain adjustment mechanism being shifted to the first position when it has been determined that the electronic apparatus is situated close to the expansion apparatus.

13. An electronic apparatus system, comprising:
an electronic apparatus including a first light-emitting section which transmits an optical signal, a first light-receiving section which receives an optical signal, and at least a first optical filter provided in front of the first light-emitting section and the light-receiving section, the first optical filter selectively passing therethrough optical signals; and
an expansion apparatus which expands a function of the electronic apparatus, the expansion apparatus including
a mount section which dismountably mounts thereon the electronic apparatus,
a second light-emitting section which transmits an optical signal to the first light-receiving section,
at least a second light-receiving section which receives an optical signal from the first light-emitting section,
a second optical filter provided in front of the second light-emitting section and the second light-receiving section, the second optical filter selectively passing therethrough optical signals, and
an optical attenuation filter which attenuates an optical signal exchanged between the expansion apparatus and the electronic apparatus, the optical attenuation filter being movable between a first position in which the optical attenuation filter is advanced in front of the second light-emitting section and the second light-receiving section, and a second position in which the optical attenuation filter is retracted from being in front of the second light-emitting section and the second light-receiving section, the optical attenuation filter being shifted to the first position when the electronic apparatus is mounted on the mount section, and to the second position when the electronic apparatus is dismounted from the mount section.

14. The electronic apparatus system according to claim 13, wherein the expansion apparatus includes a detection section which detects whether or not the electronic apparatus is mounted on the mount section, and an operation mechanism which moves the optical attenuation filter to one of the first position and the second position based on a detection result of the detection section.

15. The electronic apparatus system according to claim 13, wherein the optical attenuation filter is aligned with the second optical filter when the optical attenuation filter is in the first position.

16. A device for communicating with an external device, comprising:
optical communicating means for communicating with the external device by using an optical signal;
means for detecting a distance from the external device; and
means for adjusting a gain of the optical signal based on the distance detected by the means for detecting.

17. The device according to claim 16, wherein the means for detecting determines whether the distance is less than a predetermined range.

18. The device according to claim 16, wherein the means for adjusting includes means for reducing the gain when the distance is less than a predetermined range.

19. The device according to claim 18, wherein the means for adjusting includes an optical filter, and means for moving the optical filter between a first position in an optical path through which the optical signal passes, and a second position away from the optical path through which the optical signal passes.

20. A method of communication between a first device and a second device using an optical signal, comprising:
detecting a first distance between the first device and the second device;
adjusting a gain of the optical signal to a first level when the first distance is detected;
detecting a second distance shorter than the first distance between the first device and the second device; and
adjusting the gain of the optical signal to a second level lower than the first level when the second distance is detected.
